(19) United States
(12) Patent Application Publication
(10) Pub. No.: US 2024/0069662 A1
(43) Pub. Date: Feb. 29, 2024

(54) MACHINE CONTROLLER

(71) Applicant: Anne DeWitte, Fairport, NY (US)

(72) Inventor: Anne DeWitte, Fairport, NY (US)

(21) Appl. No.: 17/897,163

(22) Filed: Aug. 28, 2022

(51) Int. Cl. G06F 3/041; G06F 3/04847; G06F 3/0488

(52) U.S. Cl. CPC G06F 3/0416; G06F 3/04847; G06F 3/0488; G06F 3/044; G06F 2203/04105; G06F 2203/04108

(57) ABSTRACT

A machine controller for controlling at least one machine, the machine controller including a control surface including a plurality of alterable physical properties; and a control device is functionally connected to the control surface and configured to communicate with the at least one machine, wherein the control device is configured to change at least one of the plurality of alterable physical properties of the control surface based on a total input comprised of a first input and a second input, the first input is configured to be received from the at least one machine and the second input is configured to be received from the control surface and the control device is configured to generate an instruction to affect at least one of the control surface and the at least one machine.

### BACKGROUND OF THE INVENTION

### 1. The Field of the Invention

The present invention relates to a machine controller adaptable to each of a plurality of machines. More specifically, the present invention is directed to a machine controller having a control surface adaptable to each of a plurality of machines.

### 2. Background Art

Historically, human-machine interaction has relied on physical manipulatives, such as the handle on a lever or a dial on a radio. As machines have become more complex, our methods of interaction have evolved. Where we once used physical buttons, dials, and switches, we are now presented with virtual representations of the same objects though touchscreens. The touchscreen advantages are many: high resolution graphics, reusable surface, flexibility, lower cost to maintain, and easy to clean. However, without a tactile interface we lose usability in areas such as target acquisition and selection feedback. Although compensations have been made, a non-tactile surface is an added hardship for the visually impaired. A method for controlling a machine that combines the visual and refreshable attributes of a touchscreen with the usability and accessibility benefits of physical manipulatives would be a significant improvement in human machine interfaces.

Efforts that combine these interface attributes are found at research institutions and in intellectual property, but commercial success is limited. Much of this effort and the limited market success are focused on surface haptics, e.g., in the integration of vibrotactile feedback with touchscreens. For example, a mobile phone or smart watch will vibrate in reaction to a state change such as a phone call or incorrect pin entry. Next generation surface haptics tend to localize the vibration effect to create texture and edge sensations on a touchscreen. While there is still room for further innovation, these incremental tactile additions to a smooth touchscreen architecture will not provide the tactile bandwidth required to produce an effective physical manipulative.

Where surface haptics modify a touchscreen which is primarily visual, the interaction of a tangible user interface (TUI) is primarily tactile. For example, the Reactable music synthesizer produces digital effects through the manipulation of specialized objects placed on a touch surface. As with other TUI implementations similar to the Reactable music synthesizer, the manipulated objects are fixed shape and size. Though these objects may be easily recognizable by touch, their static structure hinders transformation of the surface for other purposes.

An alternative TUI is called a shape display. These displays use a grid of actuators to raise or lower areas on a surface that creates edges detectable by touch, i.e., dynamic shape generation. Though not as detailed as fixed shape objects, the displays create recognizable, 2.5 dimensional shapes that are refreshable. One example is the inForm® project created by the Tangible Media Group at the Massachusetts Institute of Technology. inForm® uses gestures to manipulate a surface composed of individually controlled, illuminated pins. Variations of inForm® perform tasks such as shape generation, direct tactile recognition, material simulation, and 3D data display. Despite the creativity and innovation of these projects, a commercial product directly related to this approach has yet to be realized. Market success, however, is found in refreshable, high density, pin-based surfaces for the visually impaired. The purpose of these surfaces is to dynamically generate tactile graphics and/or braille codes. For example, the product Graphiti® by Orbit® is a tablet sized device with a 60×40 matrix of refreshable pins that provides a visually impaired person access to any form of graphical information. It is worth noting, the Graphiti® and similar devices do not include visual output. Due to the high component costs and limited market size, broad placement and optimization of these devices is limited.

Every day, people of varying abilities control machines, whether the machine is a home appliance or an industrial printer. Interestingly, of all the surface haptic and tangible user interface applications, few if any are focused on machine controls beyond a simple button press or swipe. Expanding our human-machine interaction beyond the flat touch screen is a needed and underdeveloped digital application space.

There exists a need for a device and method for controlling a machine where the shape display combines the visual and refreshable attributes of a touchscreen with the usability and accessibility benefits of physical manipulatives. Further there exists a need for a device and method capable of providing universal interfaces to reduce the need for specialized and dedicated interfaces, thereby simplifying the human machine interfaces.

### SUMMARY OF THE INVENTION

In accordance with the present invention, there is provided a machine controller for controlling at least one machine, the machine controller including:
(a) a control surface including a plurality of alterable physical properties; and
(b) a control device is functionally connected to the control surface and configured to communicate via a communication with the at least one machine, wherein the control device is configured to change at least one of the plurality of alterable physical properties of the control surface based on a total input comprised of a first input and a second input, the first input is configured to be received from the at least one machine and the second input is configured to be received from the control surface and the control device is configured to generate an instruction to affect at least one of the control surface and the at least one machine.

In one embodiment, the plurality of alterable physical properties include a property selected from the group consisting of shape, color, texture, surface properties and any combinations thereof. In one embodiment, the color is configured to be displayed in a plurality of hues and a plurality of luminosity levels. In one embodiment, the shape includes a shape selected from the group consisting of a dial, a button, a switch, a slider, a knob, a directional pad and any combinations thereof. In one embodiment, the control surface includes a support structure, a shape element disposed in a first position and an intersecting relationship with respect to the support structure and an actuator configured to dispose the shape element in a second position. In one embodiment, the machine controller further includes a resilience member configured to return the shape element to the first position. In one embodiment, the actuator is further configured to dispose the shape element in the first position. In one embodiment, the machine controller further includes a shape element contact detector configured to detect a contact with the shape element, wherein the input includes a contact input to the shape element. In one embodiment, the contact is a contact selected from the group consisting of touch and pressure, the shape element contact detector for touch is a capacitive touch detector and the shape element contact detector is a resistive touch detector. In one embodiment, further including a light emitter. In one embodiment, the machine controller further includes a detector configured to detect the presence of an occurrence to trigger a third input based on the detection of the occurrence, wherein the total input further includes the third input. In one embodiment, the detector is a device selected from the group consisting of a biometric sensor, a timer, an environmental sensor, a proximity sensor and an image sensor. In one embodiment, the biometric sensor is a device selected from the group consisting of a fingerprint sensor, a face recognition sensor, an iris recognition sensor, a hand geometry sensor, a DNA sensor, a voice recognition sensor, a signature sensor, a capacitive sensor, an optical sensor, an ultrasonic sensor, an RF sensor, a thermal sensor and a pressure sensor. In one embodiment, the environmental sensor is a device selected from the group consisting of a sound detector, a motion detector, a temperature detector, a humidity detector, a chemical detector, a gas detector, a liquid detector, an atmospheric pressure detector, a location detector and an orientation detector. In one embodiment, the proximity sensor is a device selected from the group consisting of an inductive proximity sensor, a capacitive proximity sensor, an ultrasonic proximity sensor and an infrared (IR) proximity sensor. In one embodiment, the machine controller further includes an audio component configured for emitting sound, wherein the audio component is functionally connected to the control device. In one embodiment, the control surface includes a support structure, a shape element disposed in a first position and an intersecting relationship with respect to said support structure and a resistance controller configured to present a variable resistance to a movement of said shape element to a second position.

An object of the present invention is to provide a human-machine interface that is adaptable to control at least one machine.

Another object of the present invention is to provide a human-machine interface that supplies adaptable tactile interactions.

Another object of the present invention is to provide a human-machine interface that supplies adaptable multi-modal interactions including tactile, visual and audio interactions.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a diagram depicting one example of a machine controller configured for communicating with one of a plurality of machines.

FIG. 2 is a diagram depicting one example of a machine controller configured for communicating with one of a plurality of machines.

FIG. 3 is a diagram depicting one example of a machine controller configured for communicating with one of a plurality of machines.

FIG. 4 is a block diagram depicting an interaction of a present machine controller with a one of a plurality of machines.

FIG. 5 is an example of a control surface of a present machine controller.

FIG. 6 is an example of a control surface of a present machine controller.

FIG. 7 is an example of a control surface of a present machine controller.

FIG. 8 is an example of a control surface of a present machine controller.

FIG. 9 is an example of a control surface of a present machine controller.

FIG. 10 is a diagram depicting an example of a control surface of a present machine controller.

FIGS. 11-12 depict an example of a control surface of a present machine controller.

FIG. 13 is a diagram depicting an example of a control surface of a present machine controller.

FIG. 14 is a diagram depicting one example of a machine controller configured for communicating with one of a plurality of machines.

### PARTS LIST

2—machine controller
4—machine
6—control surface
7—support structure
8—control device
10—alterable physical property of control surface
12—alterable physical property of control surface
14—communication
16—surface feature
18—surface feature
20—surface feature
22—surface feature
24—head
26—post
28—resilience member or spring
30—actuator or combined actuator and sensor
32—plate
34—light emitter
36—shape element
37—surface feature
38—switch at off state
40—switch at on state
42—shape element
44—shape element
46—shape element
48—shape element
50—input sensor
52—axis
54—user
56—sensor or detector
58—well
60—resistive fluid
62—rod
63—block
64—finger of a user
66—shape element in depressed position
68—direction

### PARTICULAR ADVANTAGES OF THE INVENTION

The present machine controller provides tactile operation of an adaptable human-machine interface, thereby improving the usability and accessibility for sighted and not sighted users.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

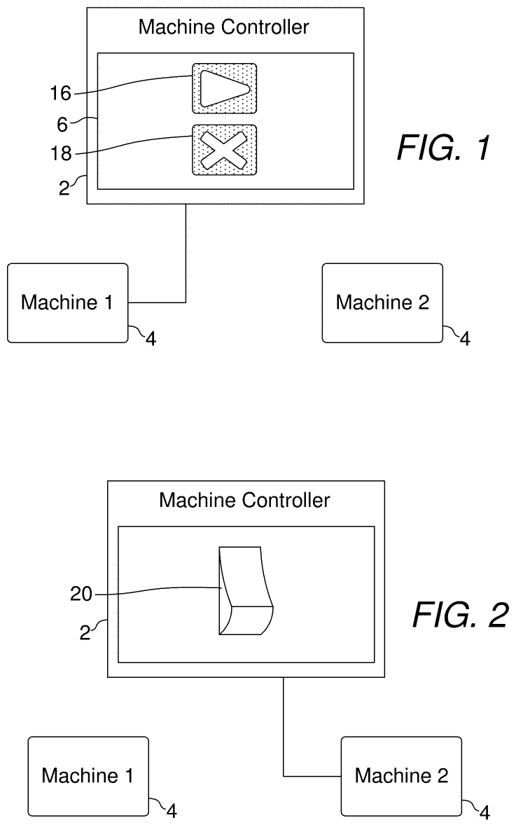

Disclosed herein is a machine controller 2 for controlling at least one machine 4. FIG. 1 is a diagram depicting one example of a machine controller 2 configured for communicating with one of a plurality of machines 4, i.e., Machine 1 and Machine 2. As shown in this figure, a communication is shown to occur between the machine controller 2 and Machine 1 with a line drawn to connect the machine controller 2 and Machine 1. The machine controller 2 includes a surface feature 16 and a surface feature 18. In one embodiment, a surface feature is depressible. For instance, in interacting with the surface features 16, 18, a user may depress each surface feature to select a function the surface feature represents. For instance, the central part of surface feature 16 appears as a triangle with one of its peaks pointing to the right. This symbol is universally understood as a “play” button. Therefore, upon getting the button depressed, the user of the machine controller 2 expects the machine 4 to perform a certain “play” function, e.g., the playing of a movie at the machine 4, etc. The central part of surface feature 18 appears as an “X.” This symbol is universally understood as a “stop” button. Therefore, upon getting the button depressed, the user of the machine controller 2 expects the machine 4 to stop certain activity that was associated with the “play” function started with the “play” button. A conventional controller includes a set of fixed and pre-configured buttons where the conventional controller is only useful for controlling one machine or one type of machines. Therefore, its function is limited and for each machine, a separate machine controller is required. It is this limitation that the Applicant sought to overcome. Although a machine controller can be programmed to output a unique screen display when connected to a particular machine, the conventional controller is incapable of providing an interface screen having surface features that can be detected by a user's tactile sensory organs. It is possible to provide a generic interface including all possible surface features which a user may distinguish from one another. However, such an interface would almost be overly expansive in its surface features, rendering its relevant surface features for a particular machine the controller interacts with, difficult to be discerned from other unrelated surface features on the interface, even also with the aid of vision. Therefore, for a machine controller to be tactilely useful while capable of interfacing with various machines (which require different sets of features), the machine controller must be capable of providing only tactile features relevant to the various machines.

FIG. 2 is a diagram depicting one example of a machine controller configured for communicating with one of a plurality of machines 4. As shown in this figure, a communication is shown to occur between the machine controller 2 and Machine 2 with a line drawn to connect the machine controller 2 and Machine 2. Here, as Machine 2 performs one or more functions that are different from Machine 1, the surface feature/s required of Machine 2 at the machine controller 2 are different from those found on the machine controller 2 when it interacts with Machine 1. Here, the surface feature 20 shown is a switch.

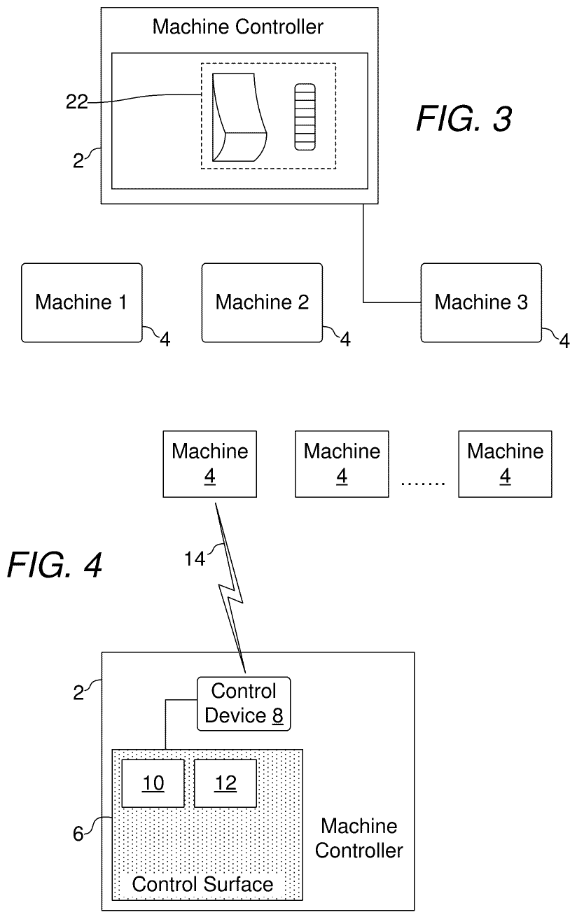

FIG. 3 is a diagram depicting one example of a machine controller configured for communicating with one of a plurality of machines. Again, a communication is shown to occur between the machine controller 2 and a machine 4. Here, a line has been drawn to connect the machine controller 2 and Machine 3. Here, as Machine 3 performs one or more functions that are different from Machine 1 or Machine 2, the surface feature/s required of Machine 3 at the machine controller 2 are different from those found on the machine controller 2 when it interacts with Machine 1 or Machine 2. Here, the surface feature 22 shown is a switch with an adjustment mechanism.

FIG. 4 is a block diagram depicting an interaction of a present machine controller 2 with a one of a plurality of machines 4. The machine controller 2 includes a control surface 6 including a plurality of alterable physical properties, e.g., physical properties 10, 12; and a control device 8 functionally connected to the control surface 6. The control device 8 is configured to communicate via a communication with a machine 4. In one embodiment, the communication 14 is a wireless communication. In another embodiment, the communication is a wired communication. In one example, the communication includes transfer of data indicating the type or configuration of the machine to the machine controller 2. In another example, the communication includes gathering of data by the machine controller 2 of the machine 4 based on a visual technique, e.g., via a QR code. The control device 8 is configured to change at least one of the plurality of alterable physical properties of the control surface 6 based on a total input comprised of a first input and a second input. The first input is configured to be received from the machine 4 and the second input is configured to be received from the control surface. The control device 8 is configured to generate an instruction to affect at least one of the control surface 6 and the machine 4. For instance, when a machine completes a task, it conveys a status as a first input to the control device 8 such that the control device can issue an instruction to the control surface 6 that reflects the status of the machine 4, toggling a button to indicate that the machine is ready for another task. In another instance, when a machine needs to be paused during the execution of a task, a “pause” button on the control surface 6 can be pressed to alter its state to indicate that the task is being paused at the machine 4 while an instruction is communicated to the machine 4 for the task to be paused. An alterable physical property can be the shape, color, texture, surface properties or any combinations of these physical properties. In one embodiment, the shape includes a shape selected from the group consisting of a dial, a button, a switch, a slider, a knob, a directional pad and any combinations thereof. In one embodiment, the machine controller further includes an audio component configured for emitting sound, where the audio component is functionally connected to the control device.

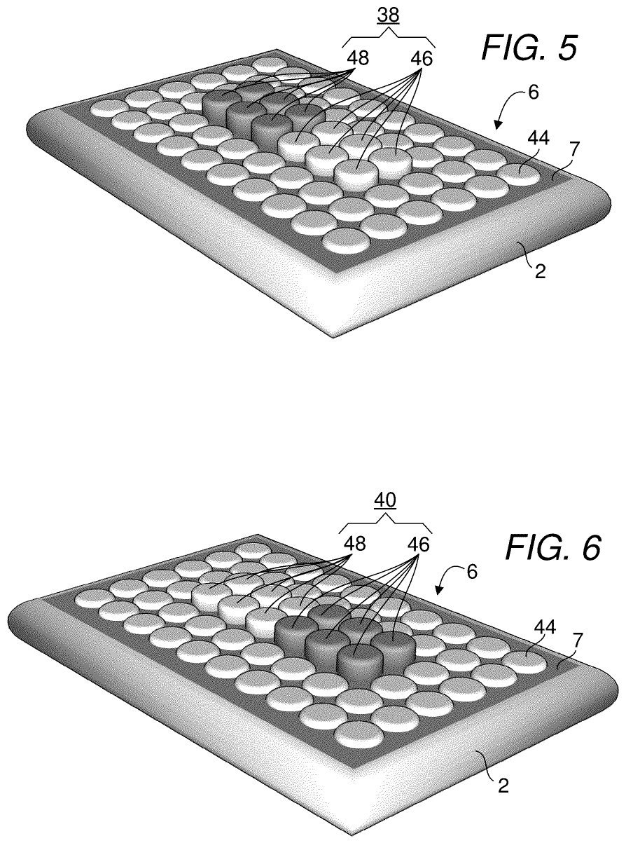

FIG. 5 is an example of a control surface of a present machine controller 2. It shall be noted that the control surface 6 includes a surface texture or feature defined by shape elements disposed at different heights. For instance, shape elements 44 are disposed at a lowest level while shape elements 46 are disposed at a level higher than shape elements 44. Shape elements 48 are disposed at a level higher than both groups of shape elements 44 and 46. Together, groups of shape elements 46 and 48 represent a surface feature in the form of a switch 38 disposed in its “off” state. The difference in height between at least two shape elements helps define at least one surface feature. It shall be appreciated that by selectively varying the heights of the shape elements, surface features of different shapes can be formed. For instance, the shapes shown in FIGS. 1-3 can be formed by selectively raising shape elements at various areas of the control surfaces 6 shown in these figures. As shown elsewhere herein, the illumination associated with each shape element can also be altered in real-time, just as the height of the shape element, to provide a color to a shape element when viewed by a user of the control surface.

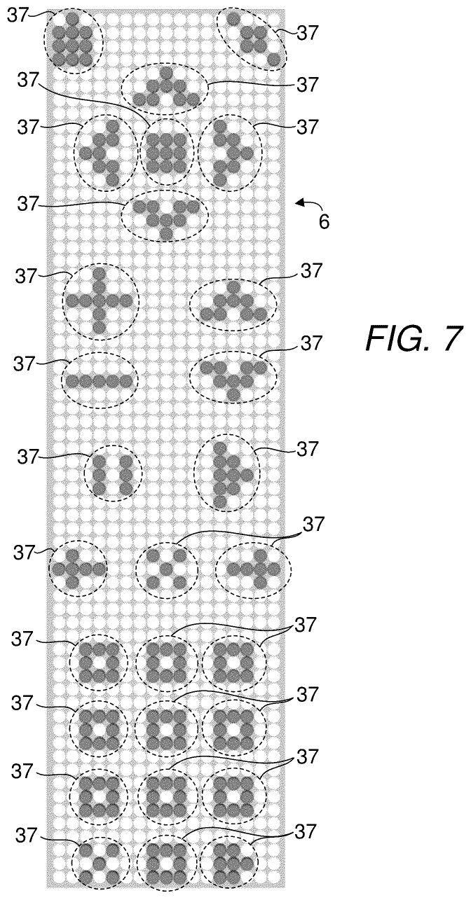

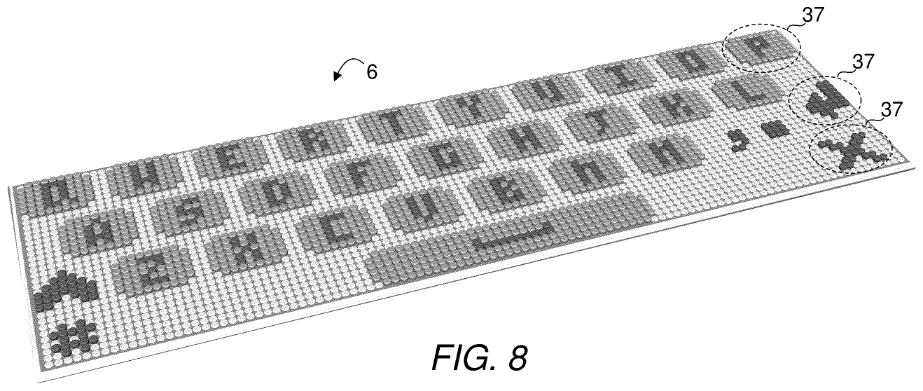

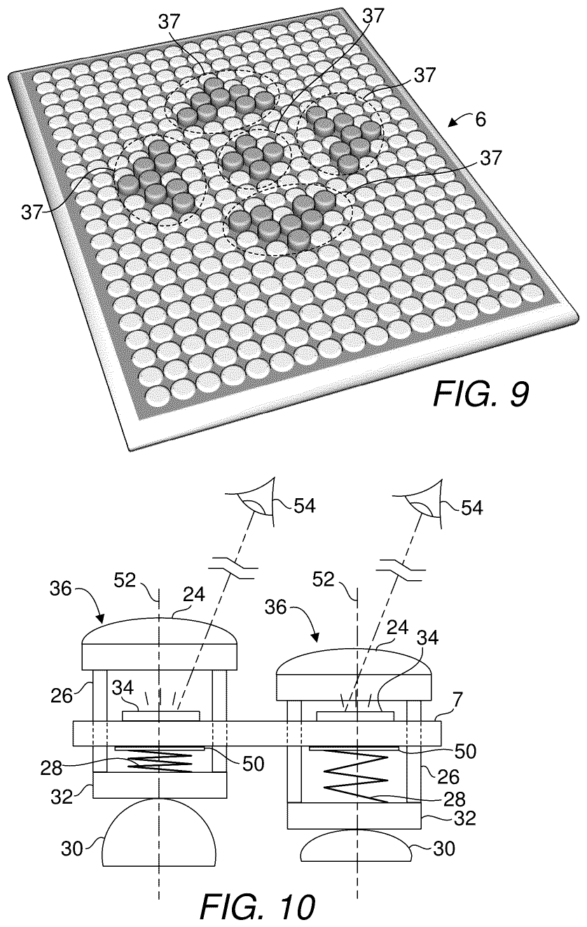

FIG. 6 is an example of a control surface of a present machine controller. Referring back to FIG. 5, shape elements 46 and 48 together represent a switch 38 in the “off” state. Here, groups of shape elements 46 and 48 together represent the switch of FIG. 5 now being disposed in the “on” state with the switch 40 of FIG. 5 having been pressed. It shall be noted that as the shape elements 46 in FIG. 6 are now disposed in a shade or illuminated state that is different from the shape elements 46 shown in FIG. 5. FIG. 7 is an example of a control surface of a present machine controller. With a sufficiently large control surface 6, i.e., a surface with sufficiently numerous shape elements, the shape elements can collectively display one or more features where a feature can be a physical manipulative. Here, the control surface 6 is configured as a universal remote controller as the surface is sufficiently large to allow various surface features 37 to be made available. FIG. 8 is an example of a control surface of a present machine controller. Here, the control surface 6 is configured as a keyboard as the surface is sufficiently large to allow various surface features 37 to be made available. FIG. 9 is yet another example of a control surface of a present machine controller. Here, the control surface 6 is configured as a directional pad as the surface is sufficiently large to allow various surface features 37 to be made available. Each surface feature 37 is formed in the shape of a triangle on the periphery of a collection of triangles orientated in a diamond shape and a cross disposed in the center of the diamond shape. In this instance, each surface feature 37 in this figure is a physical manipulative, that when pressed, would send an input to a control device which would in turn send an instruction to a machine in a direction indicated by the physical manipulative. Referring to FIGS. 7-9, the differences in shade or illuminated state are used to enhance the groups of shape elements or surface features 37. It shall be noted that the groups of shape elements, formed in the shape of a circle, triangle, oval, square or rectangle, may be distinguished from their surroundings by using one or more shades or colors. The shape elements may additionally be disposed at one or more levels that are different from the level at which the surroundings of the groups of shape elements are disposed.

FIG. 10 is a diagram depicting an example of a control surface of a present machine controller. Only two shape elements 36 are shown. The control surface includes a support structure 7, the shape element on the right side is disposed in a first position and an intersecting relationship with respect to the support structure 7 and an actuator configured to dispose the shape element in a second position as shown in the shape element disposed on the left side. The shape element 36 on the left side is disposed in a raised condition while the shape element 36 on the right side is disposed in a lowered condition. Each shape element includes a head 24, e.g., a lens, a base plate 32, a member, e.g., at least one post 26, connecting the head 24 and the base plate 32 and an actuator 30 configured to mobilize the shape element along a central axis 52 where the at least one post 26 is disposed through and supported by the support structure 7. In one embodiment, the shape element 36 further includes at least one of an input sensor 50, e.g., a touch, e.g., capacitive, or a pressure, e.g., resistive sensor. In the embodiment shown, the actuator includes an actuator 30 configured to raise the shape element and a spring 28 to lower the shape element. In an embodiment not shown, the actuator includes only a double-acting actuator 30 capable of raising and lowering the shape element as the double-acting actuator 30 would be capable of exerting a force along the central axis 52 in a first direction and a second direction opposite the first direction. Referring back to FIG. 5, it shall be noted that the shape element 36 on the left of FIG. 10 may be applied to a shape element 48 of the group of shape elements 48, i.e., the shape elements 48 are disposed in a raised condition and the shape element 36 on the right of FIG. 10 may be applied to a shape element 46 of the group of shape elements 46, i.e., the shape elements 46 are disposed in a state where the shape elements are raised but to a level that is lower than the shape elements 48. In the embodiment shown, the input sensor 50 is disposed between spring 28 and support structure 7. It shall be noted that, the level of compression of the spring 28 and hence a force exerted on the input sensor, applied, e.g., by a user's finger 64, through a press along substantially the central axis 52 and a force applied by the actuator 30 along the central axis 52, dictates the amount of force sensed by the input sensor 50 which corresponds to the position of the shape element. Alternatively, the input sensor 50 may be disposed at another location as long as a position of the shape element can cause a pressure exertion or capacitive influence to be sensed by the input sensor. In one embodiment, the support structure 7 can include a printed circuit board (PCB) through which a shape element is disposed. In one embodiment, the control surface 6 further includes a light emitter 34. As the head 24 is transparent, light emitted from light emitter 34 through the head 24 is visible to a user 54. In one embodiment, the light emitter 34 can be configured to emit a light of a plurality of colors, hues and luminosity levels. In one embodiment, the output of the light emitter 34 can be altered commensurate to an input to the input sensor 50. In one embodiment, the output of the light emitter 34 can be altered commensurate to the first input. In one embodiment, a rapid cycle of the actuation and de-actuation of the shape element 36 can produce a vibrational effect as an additional control surface attribute useful for engaging an interaction of a user 54.

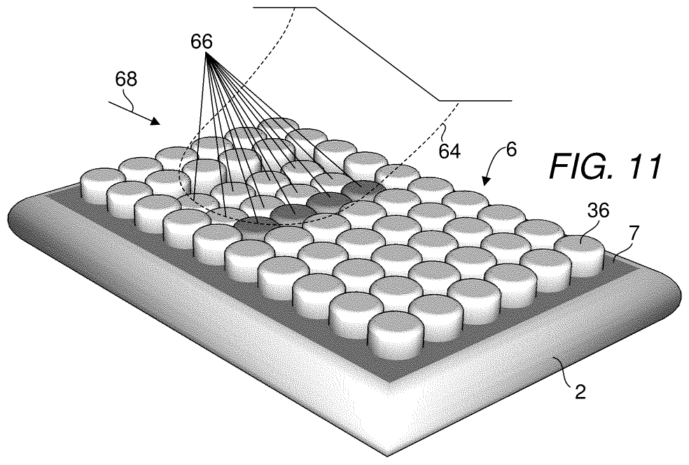

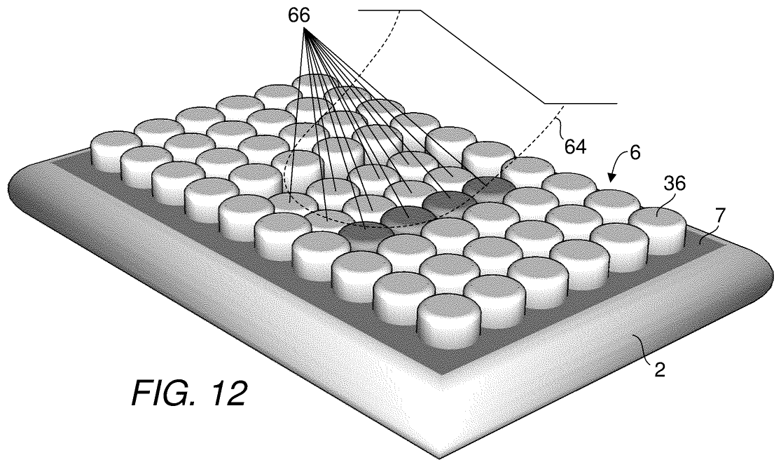

FIGS. 11-12 depict an example of a control surface of a present machine controller. In this embodiment, a surface feature is identified by shape elements that exhibit a lower resistance to a downward force. It shall be noted that, without any force input, the shape elements 36 are disposed in their default raised state. In this embodiment, a force must be exerted upon the shape elements 36 to reveal a dynamic surface feature that is a slider as encompassed by the aggregate of shape elements 66 of FIGS. 11-12. Surface elements 66 are used to show the slider that is formed when a downward force is exerted in direction 68 on the control surface, causing a signal to be generated based on a slider value corresponding to the position and/or downward force of the user input along the slider. A shape element can be disposed in a different illuminated state to indicate the presence of a surface feature. Here, four shape elements in a row are disposed in a contrasting illuminated state to indicate to the user, the presence, position and direction of the slider.

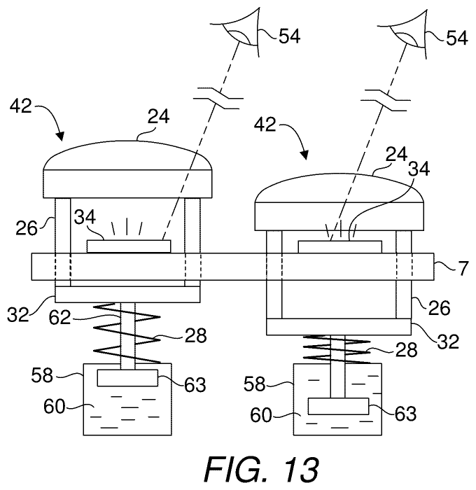

FIG. 13 is a diagram depicting an example of a control surface of a present machine controller. In contrast to the shape elements of FIG. 10, each of the shape elements of FIG. 13 does not include an actuator 30. Here, the presence of a surface feature is identified by a contrast in shape element resistance to a downward force. In one embodiment, a surface feature is identified by shape elements of lesser resistance to a downward force compared to shape elements disposed adjacent to these shape elements. In another embodiment, a surface feature is identified by shape elements of higher resistance to a downward force compared to shape elements disposed adjacent to these shape elements. The resistance to the downward force is controllable by a resistance controller. Only two shape elements 42 are shown. The shape element 42 on the left side is disposed in a high resistive condition while the shape element 42 on the right side is disposed in a lower resistive condition as evidenced by the deeper penetration of block 63 in the well 58. Each shape element includes a head 24, e.g., a lens, a base plate 32, a member, e.g., at least one post 26, connecting the head 24 and the base plate 32, a spring 28 disposed between a well 58 and the base plate 32 and a resistance controller. The resistance controller includes a rod 62 terminated on one end with a block 63, the well 58 and a resistive fluid 60 disposed therein. In the embodiment, the force resistance experienced in pressing in a shape element 42 is proportional to an electrical resistance of the resistive fluid 60. It is this electrical measure that provides a touch indicator. By increasing the viscosity of the resistive fluid 60, the resistance to the downward force applied on a shape element 42 is increased due to the increased resistance experienced in moving the block 63 through the resistive fluid 60. By decreasing the viscosity of the resistive fluid 60, the resistance to the downward force applied on a shape element 42 is decreased as the resistance experienced in moving the block 63 decreases, allowing spring 28 to return the shape element 42 to its default raised state as shown in the shape element 42 on the left side of FIG. 13. In one embodiment, the resistive fluid is a rheological fluid. Again, in one embodiment, the support structure 7 can include a printed circuit board (PCB) through which a shape element 42 is disposed. In one embodiment, the control surface 6 further includes a light emitter 34. As the head 24 is transparent, light emitted from light emitter 34 through the head 24 is visible to a user 54. In one embodiment, the light emitter 34 can be configured to emit a light of a plurality of colors, hues and luminosity levels. In one embodiment, the output of the light emitter 34 can be altered commensurate to the electrical resistance of the resistive fluid 60. In one embodiment, the output of the light emitter 34 can be altered commensurate to the first input.

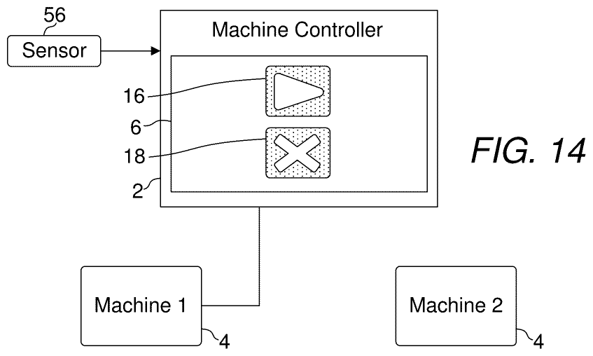

FIG. 14 is a diagram depicting one example of a machine controller configured for communicating with one of a plurality of machines. In this embodiment, the machine controller further includes a detector 56 configured to detect the presence of an occurrence to trigger a third input based on the detection of the occurrence, wherein the total input further includes the third input. The detector can be a biometric sensor, a timer, an environmental sensor, a proximity sensor or an image sensor. The biometric sensor can be a fingerprint sensor, a face recognition sensor, an iris recognition sensor, a hand geometry sensor, a DNA sensor, a voice recognition sensor, a signature sensor, a capacitive sensor, an optical sensor, an ultrasonic sensor, an RF sensor, a thermal sensor or a pressure sensor. The environmental sensor can be a sound detector, a motion detector, a temperature detector, a humidity detector, a chemical detector, a gas detector, a liquid detector, an atmospheric pressure detector, a location detector or an orientation detector. The proximity sensor can be an inductive proximity sensor, a capacitive proximity sensor, an ultrasonic proximity sensor or an infrared (IR) proximity sensor.

The detailed description refers to the accompanying drawings that show, by way of illustration, specific aspects and embodiments in which the present disclosed embodiments may be practiced. These embodiments are described in sufficient detail to enable those skilled in the art to practice aspects of the present invention. Other embodiments may be utilized, and changes may be made without departing from the scope of the disclosed embodiments. The various embodiments can be combined with one or more other embodiments to form new embodiments. The detailed description is, therefore, not to be taken in a limiting sense, and the scope of the present invention is defined only by the appended claims, with the full scope of equivalents to which they may be entitled. It will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used. The scope of the embodiments should be determined with reference to the appended claims, along with the full scope of equivalents to which such claims are entitled.

1. A machine controller for controlling at least one machine, said machine controller comprising:
(a) a control surface comprising a plurality of alterable physical properties; and
(b) a control device is functionally connected to said control surface and configured to communicate via a communication with the at least one machine, wherein said control device is configured to change at least one of said plurality of alterable physical properties of said control surface based on first input and a second input, said first input is configured to be received from the at least one machine and said second input is configured to be received from said control surface and said control device is configured to generate an instruction to affect said control surface in response to said first input and said control device is further configured to generate an instruction to affect the at least one machine in response to said second input.

2. The machine controller of claim 1, wherein said plurality of alterable physical properties comprise a property selected from the group consisting of shape, color, texture, surface properties and any combinations thereof.

3. The machine controller of claim 2, wherein said color is configured to be displayed in a plurality of hues and a plurality of luminosity levels.

4. The machine controller of claim 2, wherein said shape comprises a shape selected from the group consisting of a dial, a button, a switch, a slider, a knob, a directional pad and any combinations thereof.

5. The machine controller of claim 1, wherein said control surface comprises a support structure, a shape element disposed in a first position and an intersecting relationship with respect to said support structure and an actuator configured to dispose said shape element in a second position.

6. The machine controller of claim 5, further comprising a resilience member configured to return said shape element to said first position.

7. The machine controller of claim 5, wherein said actuator is further configured to dispose said shape element in said first position.

8. The machine controller of claim 5, further comprising a shape element contact detector configured to detect a contact with said shape element, wherein said second input comprises a contact input to said shape element.

9. The machine controller of claim 8, wherein the contact is a contact selected from the group consisting of touch and pressure, said shape element contact detector for touch is a capacitive touch detector and said shape element contact detector is a resistive touch detector.

10. The machine controller of claim 1, further comprising a light emitter.

11. The machine controller of claim 1, further comprising a detector configured to detect the presence of an occurrence to trigger a third input based on the detection of said occurrence, wherein said total input further comprises said third input.

12. The machine controller of claim 11, wherein said detector is a device selected from the group consisting of a biometric sensor, a timer, an environmental sensor, a proximity sensor and an image sensor.

13. The machine controller of claim 12, wherein said biometric sensor is a device selected from the group consisting of a fingerprint sensor, a face recognition sensor, an iris recognition sensor, a hand geometry sensor, a DNA sensor, a voice recognition sensor, a signature sensor, a capacitive sensor, an optical sensor, an ultrasonic sensor, an RF sensor, a thermal sensor and a pressure sensor.

14. The machine controller of claim 12, wherein said environmental sensor is a device selected from the group consisting of a sound detector, a motion detector, a temperature detector, a humidity detector, a chemical detector, a gas detector, a liquid detector, an atmospheric pressure detector, a location detector and an orientation detector.

15. The machine controller of claim 12, wherein said proximity sensor is a device selected from the group consisting of an inductive proximity sensor, a capacitive proximity sensor, an ultrasonic proximity sensor and an infrared (IR) proximity sensor.

16. The machine controller of claim 1, further comprising an audio component configured for emitting sound, wherein said audio component is functionally connected to said control device.

17. The machine controller of claim 1, wherein said control surface comprises a support structure, a shape element disposed in a first position and an intersecting relationship with respect to said support structure and a resistance controller configured to present a variable resistance to a movement of said shape element to a second position.
